(19) United States
(12) Patent Application Publication
(10) Pub. No.: US 2023/0258901 A1
(43) Pub. Date: Aug. 17, 2023

(54) FIBER CARRYING STRUCTURE INSTALLATION METHODS

(71) Applicant: Corning Research & Development Corporation, Corning, NY (US)

(72) Inventors: David Montalion Dupuis, Cedar Park, TX (US); Jonathan Victor Haggar, Austin, TX (US); Cary Alan Kipke, Pflugerville, TX (US); Donald Kent Larson, Cedar Park, TX (US)

(21) Appl. No.: 18/140,713

(22) Filed: Apr. 28, 2023

Related U.S. Application Data
(63) Continuation of application No. PCT/US2021/058707, filed on Nov. 10, 2021.
(60) Provisional application No. 63/115,322, filed on Nov. 18, 2020.

(51) Int. Cl. G02B 6/44; G02B 6/50

(52) U.S. Cl. CPC G02B 6/4459; G02B 6/502; G02B 6/508

(57) ABSTRACT

Several methods of deploying an optical fiber carrying structure along a road are provided. In one method a recess and channel are created within a road. The optical fiber carrying structure is deployed in the channel and a cover encloses the optical fiber carrying structure within the channel. In another method the optical fiber carrying structure is anchored to the road and/or curb. In another method the optical fiber carrying structure is coupled to a brace that is affixed to the road. The brace facilitates quickly installing lateral transitions from the primary channel in the road to installation environments off the road.

### CROSS-REFERENCED TO RELATED APPLICATIONS

This application is a continuation of International Application No. PCT/US2021/ 058707 filed Nov. 10, 2021, which claims the benefit of priority of U.S. Provisional Application Serial No. 63/115,322 filed on Nov. 18, 2020, the content of which is relied upon and incorporated herein by reference in its entirety.

### BACKGROUND

The present disclosure is related to deploying optical fiber carrying structures along hard surface pathways, such as a road. Optical fiber cables are used to transmit data over distance. Leveraging a pre-existing network, such as a road, can facilitate deploying optical fiber cables to residential homes, commercial buildings or the like.

### SUMMARY

One embodiment of the disclosure relates to deploying an optical fiber cable by creating a recess and a channel within a road. The channel is created in the road within the recess. The recess is wider and shallower than the channel, and the channel extends from a bottom surface of the recess. An optical fiber cable is placed through the recess and into the channel, and a cover, such as tape, is placed within the recess above the optical fiber cable. The cover encloses the optical fiber cable within the channel.

In another embodiment the disclosure relates to deploying an optical fiber cable by creating two channels in a road. One of the channels extends along the road, such as a small distance from a side of the road, and the other channel extends between the first channel and the side of the road. An optical fiber cable is coupled to a brace. A first portion of the optical fiber cable extends from the brace in a first direction within the first channel and a second portion of the optical fiber cable extends from the brace at a second direction within the second channel. In various embodiments the angle between the first direction and the second direction is between 70 and 110 degrees.

In yet another embodiment the disclosure relates to deploying an optical fiber cable by identifying a channel. In various deployments, the material is one of a curb, a roadbed, a sidewalk, a gutter, and/or a wall. An optical fiber cable is placed within the channel and coupled to an anchor. The anchor is driven into the channel, and as a result the anchor restrains the optical fiber cable within the channel.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 depicts a road in which a recess and a channel have been created, according to an exemplary embodiment;

FIG. 2 schematically depicts the path of the cable in FIG. 1 under a white cover, according to an exemplary embodiment;

FIG. 3 depicts a machine that creates a recess and a channel in a road, according to an exemplary embodiment;

FIG. 4 depicts a road in which a recess and a channel have been created, according to an exemplary embodiment;

FIG. 5 depicts a schematic side view of a road in which a recess and a channel have been created, according to an exemplary embodiment;

FIG. 6 depicts a road in which a recess and a channel have been created, according to an exemplary embodiment;

FIG. 7 depicts a road with a recess covered by road tape and road backfill, according to an exemplary embodiment;

FIG. 8 schematically depicts a cable path on a road and curb, according to an exemplary embodiment;

FIG. 9 depicts a channel partly backfilled and partly covered by tape, according to an exemplary embodiment;

FIG. 10 depicts a channel in a road and curb, according to an exemplary embodiment;

FIG. 11 depicts a road with a plurality of recesses and channels, according to an exemplary embodiment;

FIG. 12 depicts a road with a plurality of recesses partially covered, according to an exemplary embodiment;

FIG. 13 depicts two braces coupled to two cables to bend the cables around the braces, according to an exemplary embodiment;

FIG. 14 depicts a brace for curving a cable, according to an exemplary embodiment;

FIG. 15 depicts a brace for curving a cable, according to an exemplary embodiment;

FIG. 16 depicts a cover positioned above a brace for curving a cable, according to an exemplary embodiment;

FIG. 17 depicts a cover affixed to a road over a brace for curving a cable, according to an exemplary embodiment;

FIG. 18 depicts several snaps adhered to a surface, the snaps coupled to a cable, according to an exemplary embodiment;

FIG. 19 depicts two of the snaps of FIG. 18 coupled to a cable, according to an exemplary embodiment;

FIG. 20 schematically depicts a cable transitioning from a road and back to the road, according to an exemplary embodiment;

FIG. 21 depicts several anchors to secure a cable in a hardened surface, such as a road curb, according to an exemplary embodiment;

FIG. 22 depicts a cable being secured by anchor, according to an exemplary embodiment;

FIG. 23 depicts a detailed view of a cable being secured to a curb by an anchor, according to an exemplary embodiment;

FIG. 24 depicts a cable secured to a curb by a plurality of anchors, according to an exemplary embodiment;

FIG. 25 depicts an anchor to secure a cable in a hardened surface, such as a road curb, according to an exemplary embodiment;

FIG. 26 is a side view of the anchor of FIG. 25, according to an exemplary embodiment;

FIG. 27 schematically depicts the anchor of FIG. 25 and a profile of a cable, according to an exemplary embodiment;

FIG. 28 is a side view of the anchor of FIG. 25, according to an exemplary embodiment;

FIG. 29 is a detailed side view of a portion the anchor of FIG. 25, according to an exemplary embodiment;

FIG. 30 depicts a portion of the anchor of FIG. 25 secured to a cable, according to an exemplary embodiment;

FIG. 31 depicts tape affixed to a road in arcing columns to define a channel, according to an exemplary embodiment;

FIG. 32 depicts tape affixed over the road depicted in FIG. 31, according to an exemplary embodiment;

FIG. 33 depicts a cable with severed strength members, according to an exemplary embodiment;

FIG. 34 depicts road tape covering a cable slowly curving to the side of the road, according to an exemplary embodiment;

FIG. 35 depicts road tape covering a cable slowly curving to the side of the road, according to an exemplary embodiment;

FIG. 36 schematically depicts a sub-unit of a cable being routed from a cable, according to an exemplary embodiment; and

FIG. 37 depicts the cable of FIG. 36 surrounded by a protective jacket, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

Referring generally to the figures, various approaches for installing fiber-to-the-home (FTTH) are described. Improvements in roadway micro-trenching, such as road cut dimensions and backfill materials, have improved FTTH performance. However, lateral transitions from the road to the home or other facility remain a time-consuming aspect of FTTH installation.

Described herein are several methods of improved lateral transitions for FTTH installations. According to one method, two channels are created from the primary cable channel in the road to the side of the road. A first channel routs the cable from the primary cable channel to the side of the road and from there to a home, commercial facility, or coiled stack of cable buried in the ground. A second channel routs the cable back to the primary channel in the road. An advantage of dual channels is that each channel only contains a single cable - or a single portion of the cable. When more than one cable is within a single channel, the cables can interfere with each other and force one or both of the cables out of the channel. Dual channels preempt this problem from occurring. In addition, a cable can be installed in dual channel lateral transitions in less time than in a single channel lateral transition as discussed herein.

According to another method, the cable is coupled to braces to force a curve in the cable. When a cable has an internal strength member, the cable is biased towards remaining generally straight. Coupling the cable to a brace can force a curve in the cable to laterally transition the cable to and from the side of the road. As discussed herein, cables can be installed in a lateral transition using a brace faster than other types of lateral transitions.

According to another method, an anchor is used to hold the cable within a channel in the road and a road curb. The anchor(s) hold the cable within the channel, matching the curvature of the curb and curb/road transition. As discussed herein, cables can be installed in a lateral transition that uses anchors faster than other types of lateral transitions.

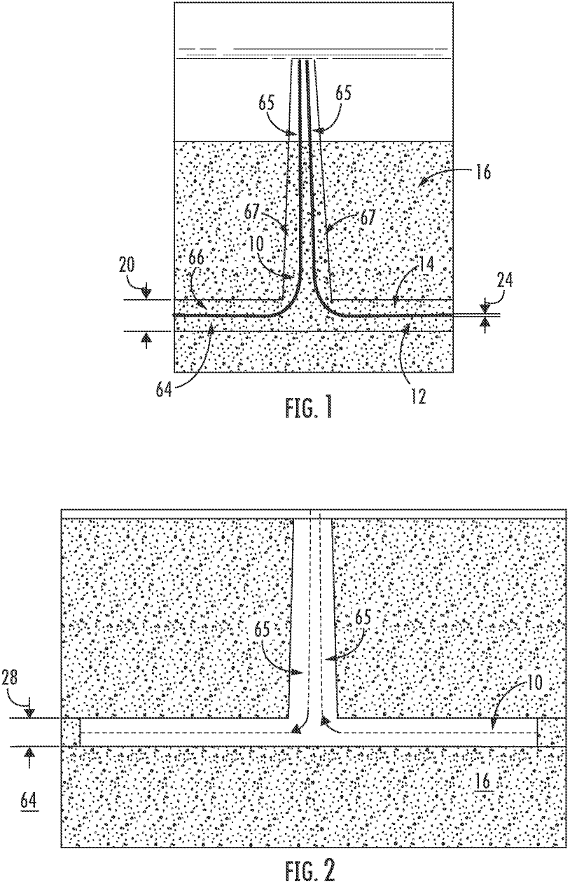

Turning to FIGS. 1-12, various methods of deploying an optical fiber carrying structure (shown as cable 10) along a hardened surface (shown as road 16) are shown. Primary recess 66 and primary channel 64 extend along road 16 parallel to the primary directions of travel. Secondary recesses 67 and secondary channels 65 extend from primary recess 66 and primary channel 64, respectively, towards a side of road 16. Cable 10 is deployed within primary channel 64 to distribute service to homes, businesses, structures, etc. near road 16. Secondary channels 65 provide routes for cable 10, or a subset of cable 10, to be diverted from primary channel 64 to the homes, businesses, structures, etc.

One advantage of using two secondary channels 65 is that cable 10 is not forced to interact with another cable 10 within a single section of secondary channel 65. Occasionally, when two cables 10 are within a single channel 14, the two cables 10 interface against each other and can push one or both of cables 10 out of channel 14. Deploying cables 10 through individual channels 14 permits cables 10 to be secured within channel 14 without being subject to external forces that will disturb their placement. It is within the scope of the present disclosure that multiple cables 10 within a single channel 14 includes the situation in which different parts of the same cable 10 are cycled past itself.

FIG. 2 schematically depicts a route that cable 10 can be deployed within channels 14. Cable 10, as indicated by the dotted line, enters from a first direction along road 16, diverts along right-most secondary channel 65 towards a facility that is being networked (e.g., a business), returns from the facility along the left-most secondary channel 65, and re-enters primary channel 64 to be routed to the next facility.

Turning to FIG. 3, a machine 74 for simultaneously creating secondary recess 67 and secondary channel 65 is shown. As shown, machine 74 has eight blades 68 that rotate and grind against road 16 to form recess 12 and channels 14. From left to right, the first and second blades 68 form the secondary recess 67 to the left of secondary channel 65, the third blade 68 forms left-most secondary channel 65, the fourth and fifth blades 68 form secondary recess 67 between secondary channels 65, the sixth blade 68 forms the right-most secondary channel 65, and the seventh and eighth blades 68 form the secondary recess 67 to the right of right-most secondary channel 65.

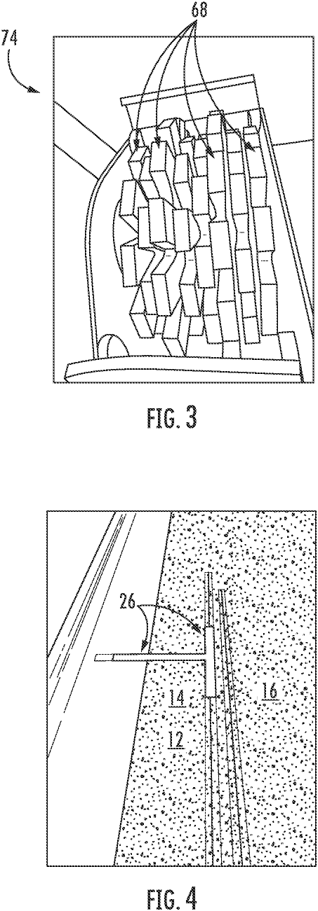

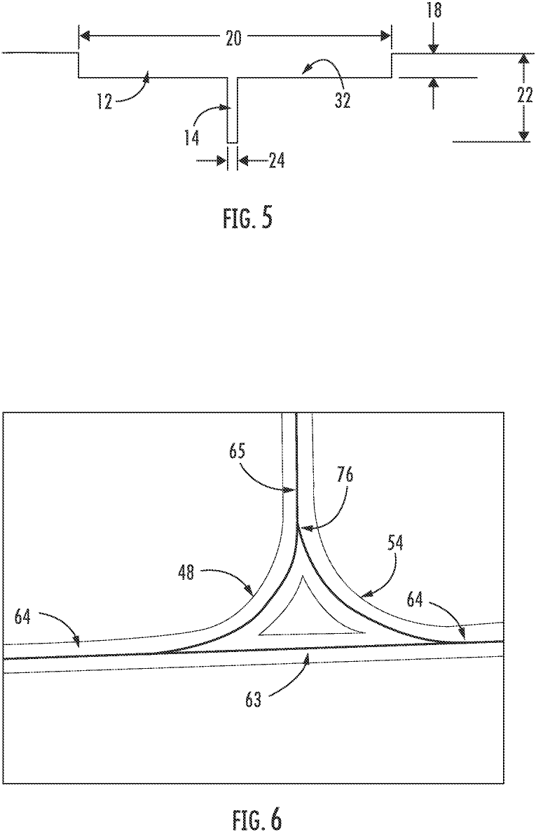

Turning to FIGS. 4 and 5, after cable 10 is placed within channel 14, a cover, shown as road tape 26, is placed within recess 12 and adhered to road 16. In one embodiment road tape 26 has a width 28 (FIG. 2) that is slightly less than the width 20 of recess 12 (e.g., road tape 26 has a width of 2″ and recess 12 has a width of 2.25″ and/or recess 12 has a width of 1″ to either side of channel 14). In a specific embodiment, recess 12 has a depth 18 of 0.25″ beneath the surface of road 16 so that a vehicle (e.g., snow plow) will not damage road tape 26 adhered to recess 12. In another specific embodiment, channel 14 has a width 24 of 0.25″ and a depth 22 of 0.75″.

In one embodiment, recesses 12 have a width 20 of 2″ and a depth 18 of ⅛ inch, and channels 14 have a width 24 of ¼ inch and a depth 22 of ¾ inch from the surface of road. Channel 14 extends downwardly from a base surface 32 of recess 12. The side walls of channels 14 are disposed between the sidewalls of recesses 12 so that the upper portion of channels 14 opens into recesses 12.

In a specific embodiment, a recess is created in the road, and a channel is created within the recess with the channel extending downward from a base surface of the recess. An optical fiber carrying structure is placed within the channel and a cover, such a tape 26, is affixed to the recess enclosing the optical fiber carrying structure within the channel.

Turning to FIG. 6, curved channel 48 and curved channel 54 connect primary channel 64 to secondary channel 65. Curved channels 48, 54 converge with secondary channel 65 at intersection 76. A single secondary channel 65 extends towards the side of road 16. In this configuration, cable 10 is positioned over itself within secondary channel 65 as cable 10 both travels to and returns from the side of road 16. In one embodiment, secondary channel 65 has sufficient depth to accept two cables. In one embodiment, cable 10 does not transit connecting channel 63 between curved channel 48 and curved channel 54. However, in a specific embodiment, connecting channel 63 is still cut because it can be difficult for a worker to start and stop cutting primary channel 64 as compared to extending primary channel 64 continuously.

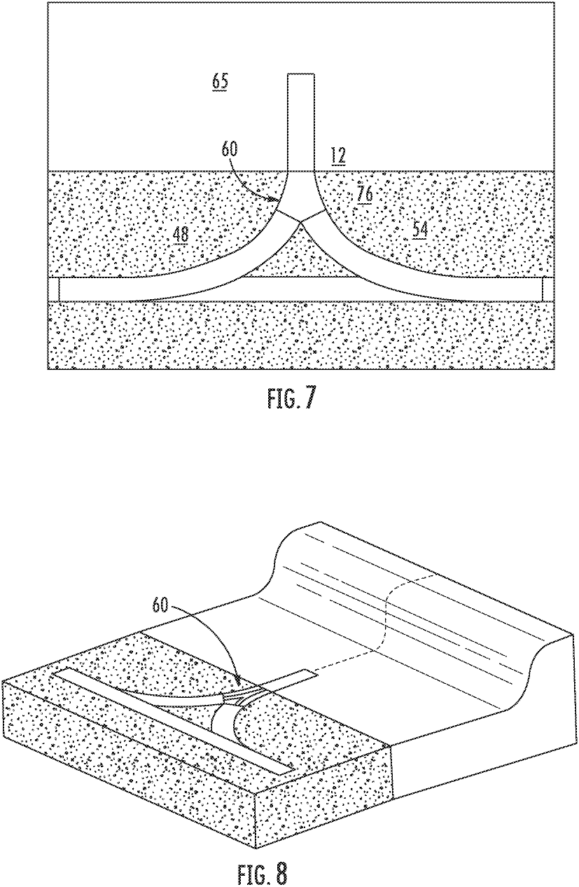

Turning to FIGS. 7 and 8, backfill 60 is placed within recess 12 at the intersection 76 of curved channels 48, 54 and secondary channel 65. One advantage of using backfill 60 at intersection 76 is to provide additional protection against damage from external elements. Backfill 60 is an alternative to using a special pentagon-shaped patch. For example, in one embodiment, recess 12 generally has a width less than 2″ to mitigate car and truck tires from damaging road tape 26 within recess 12. Because intersection 76 has a width greater than 2″, car tires may interface against the protective cover in intersection 76 so backfill 60 may be used to protect cable 10. In a specific embodiment, recess 12 by curved channels 48, 54 are also filled with backfill 60 rather than covered by tape 26.

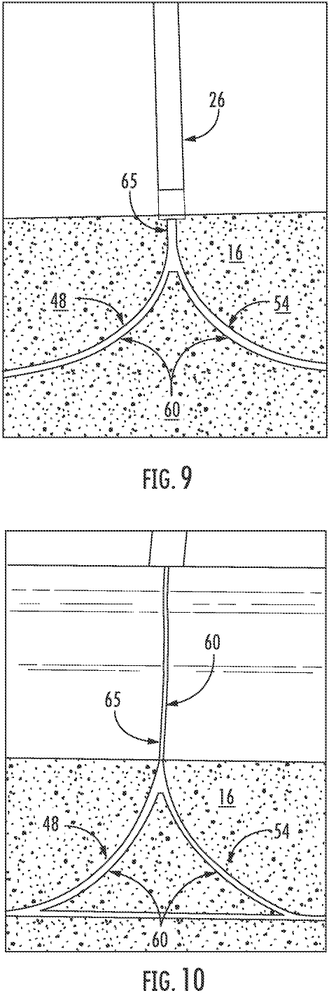

Turning to FIGS. 9 and 10, several combinations of recesses 12 and channels 14 are shown. In FIG. 9, curved channels 48, 54 are defined by road 16 and do not extend through corresponding curved recesses. In FIGS. 9 and 10, curved channels 48, 54 and secondary channel 65 are defined by road 16 and do not extend through corresponding recesses. In both FIG. 9 and FIG. 10, backfill 60 is used to fill channels 14 that are not within recesses 12.

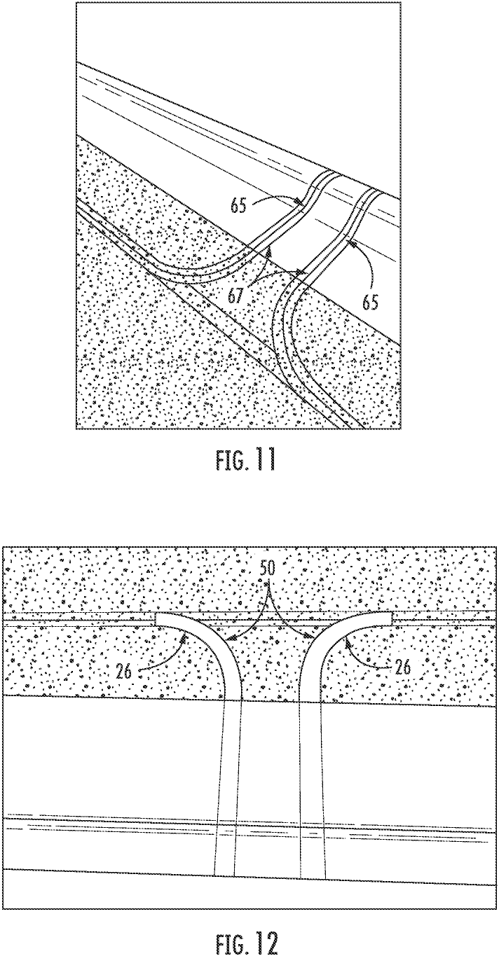

Turning to FIGS. 11 and 12, two secondary channels 65 are defined within different and distinct recesses 12, shown as secondary recesses 67. In a specific embodiment, secondary channels 65 are 6″ to 12″ apart. Turning to FIG. 12, tape 26 covers curved recess 50. In a specific embodiment, tape 26 is cut in an arcuate-shape from a larger flat sheet of tape, and as a result, tape 26 does not wrinkle, pleat, and/or stand up as tape 26 conforms to the arcuate shape of curved recess 50. In a specific embodiment, tape 26 is cut to have a larger curvature (e.g., a 12″ radius) than the arcuate shape of curved recess 50.

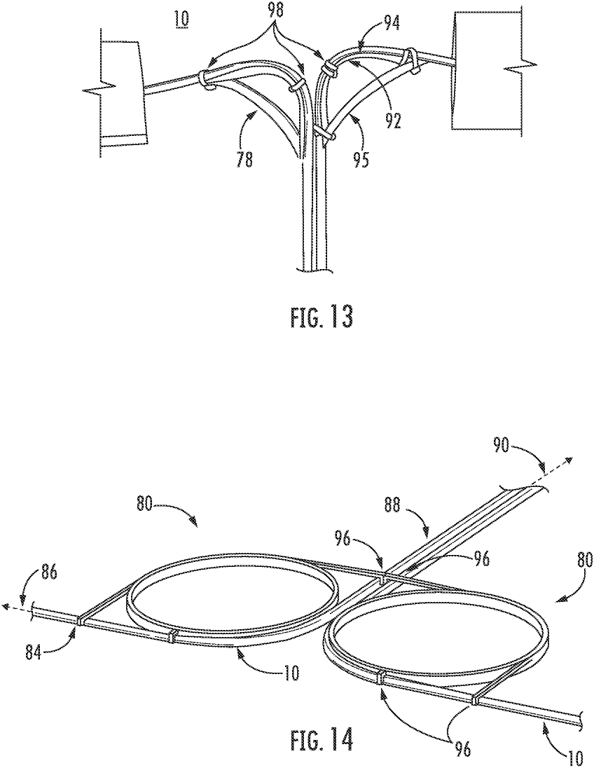

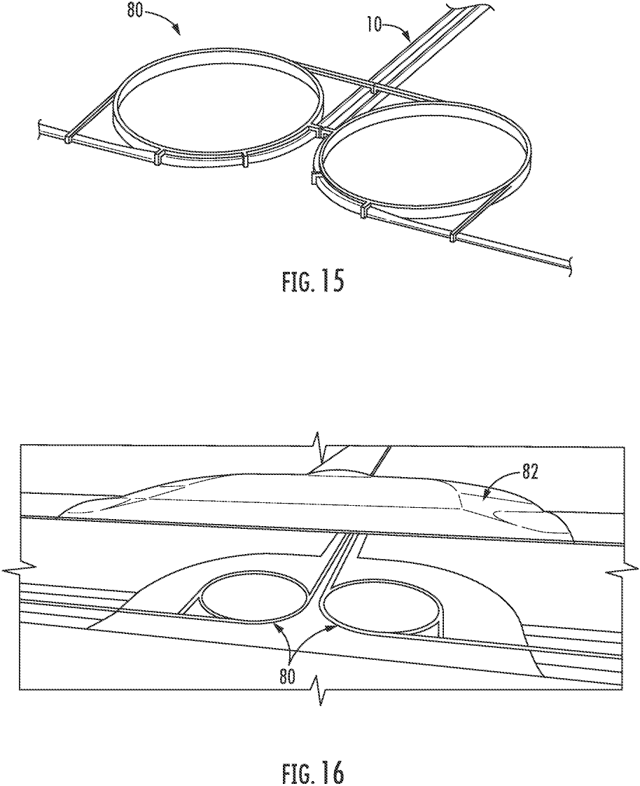

Turning to FIGS. 13-17, various embodiments of braces that force a curve into cable 10 are shown. Using braces allows workers installing cable 10 to more quickly create a lateral transition for cable 10 from road 16 to the side of road 16. Turning to FIG. 13 in particular, brace 78 includes primary wall 92 and support wall 95 extending between ends of primary wall 92. Primary wall 92 defines an outer arcuate surface 94. Cable 10 is coupled to brace 78 by fasteners 98 so that cable 10 interfaces against outer arcuate surface 94.

Turning to FIGS. 14-17, a first portion 84 of cable 10 extends from brace 80 in first direction 86, and second portion 88 of cable 10 extends from brace 80 in second direction 90. As shown in FIG. 14, second portion 88 of cable 10 is horizontally oriented, while in FIG. 15, second portion 88 of cable 10 is vertically oriented.

In one or more embodiments, fiber optic cables include two or more strength rods positioned to either side of the fiber optic communication element. Additionally, the cable may include a tone wire (e.g., a copper wire) that is positioned outside of the strength members. As a result, the cable has a generally rectangular shape. For such cables, the cable can absorb force much better when the long axis parallel to the road (horizontally oriented) than when the cable is vertically oriented. However, such cables laterally curve much easier when the cable is vertically oriented rather than horizontally oriented. For various embodiments of brace 78 and brace 80, the cable is repositioned to a vertical orientation through the curve and then reoriented to horizontal after the curve. As a result, the cable is in its more vulnerable position, vertical, for a reduced amount of distance.

Fasteners 96 couple cable 10 to brace 80. For example, cable 10 is vertically oriented during the curve while being horizontally oriented both before and after being coupled to brace 80. Brace 80 includes a circular wall that cable 10 interfaces against. Cover 82 is placed over brace 80, and road tape 26 is placed over cable 10 not covered by cover 82.

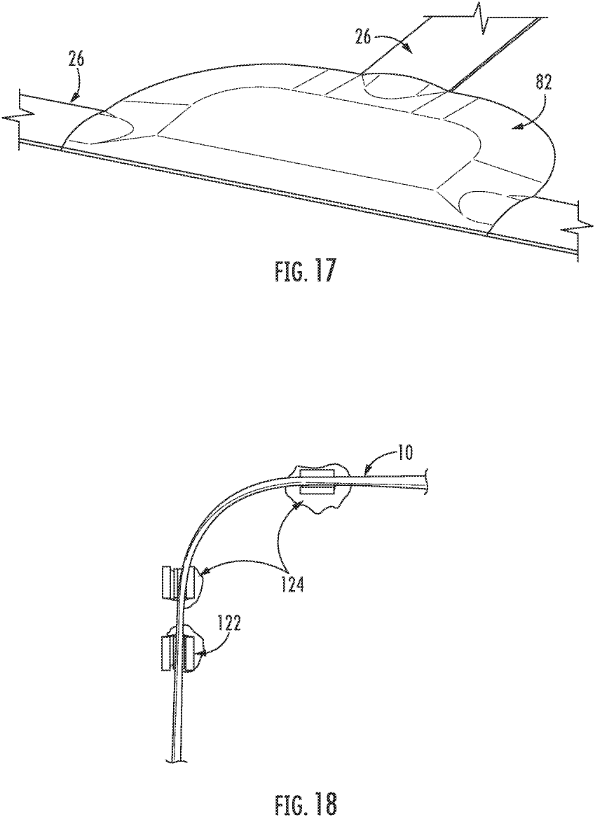

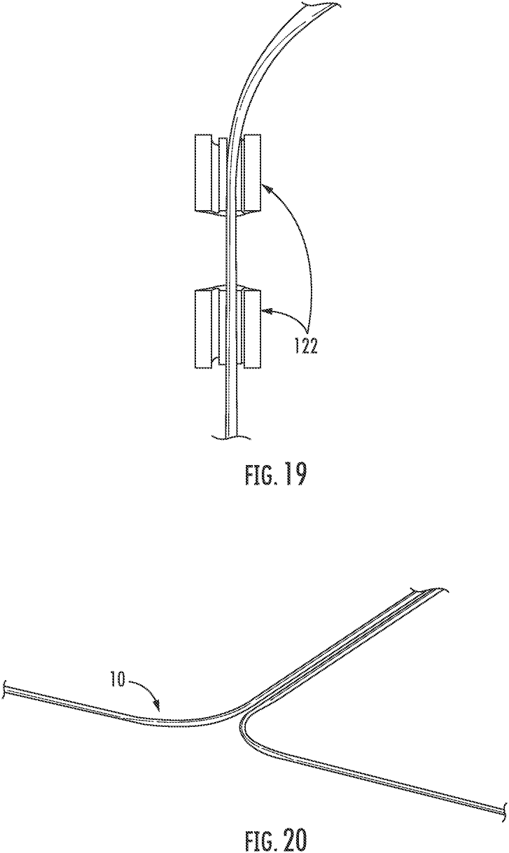

Turning to FIGS. 18-20, fasteners 122 (shown as snaps 122) are adhered to an underlying surface, such as a road, by an adhesive 124 (shown as glue 124). Subsequently, cable 10 is fastened to snaps 122. In one embodiment, cable 10 is oriented vertically while curving and oriented horizontally while straight (shown in FIG. 18).

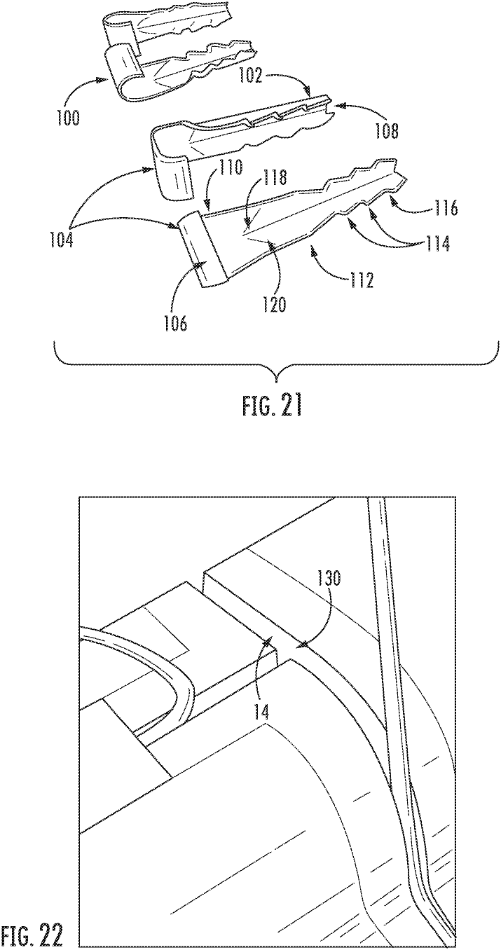

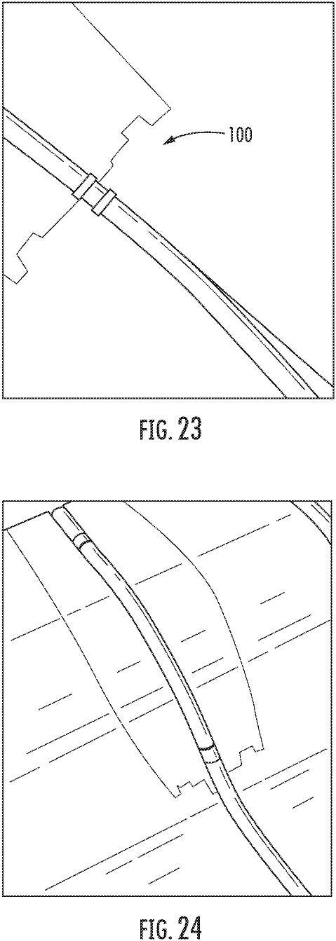

Turning to FIGS. 21-24, anchor 100 is used to secure cable 10 within channel 14. Anchors 100 are particularly useful when cable 10 resists being curved to match the form of a rolling curve such as a road curb. For example, if cable 10 has strength members that bias cable 10 to remain generally straight, then anchors 100 may be used to secure cable 10 within channel 14 in an S-bend shaped curb as shown in FIG. 22. Anchor 100 may also be used to secure cable 10 to a slotted feature in a roadway, curb, or sidewalk, such as for example in an expansion or contraction j oint. Anchor 100 has a low profile and can fit with cable 10 within channel 14. Anchor 100 may be used with existing recesses, such as a mortar line between bricks on a wall and/or a structure. FIG. 22 shows two anchors 100 used to restrain cable 10 and follow the curb profile. When anchor 100 is driven into a pilot hole, secondary wall 104 of anchor 100 curls around cable to more securely hold cable in slot.

In one embodiment, anchor 100 is used to secure cable 10 within a pre-existing channel. In one embodiment, anchor 100 is secured to channel 14 in a material, such as a masonry-type material, selected from the group consisting of a roadway, a roadbed, a curb, a sidewalk, a wall, and/or a structure.

Anchor 100 includes anchoring portion 102, which is forced into a hardened surface, such as a curb. Anchoring portion 102 interfaces against the internal structure of a curb or road 16 to secure cable 10 within channel 14. Secondary wall 104 extends from anchoring portion 102 and provides a wall to force anchor 100 into the desired location. Anchoring portion 102 has a first width 106 proximate secondary wall 104, and a second width 108 at the opposing end that is less than first width 106. Anchoring portion 102 includes first wall 118 and second wall 120. First wall 118 and second wall 120 extend from each other at an angle between 70 and 110 degrees, and more specifically, between 80 degrees and 100 degrees, and more specifically, at an angle of 90 degrees relative to each other.

First wall 118 defines first lateral surface 110 that faces away from second wall 120 and interfaces against the curb as anchor 100 is forced into the curb. Similarly, second wall 120 defines second lateral surface 112. First lateral surface 110 and second lateral surface 112 define a plurality of protrusions 114 and recesses 116. The combination of protrusions 114 and recesses 116 secure anchor 100 within the curb or road 16 that anchor 100 is placed within.

In one embodiment, a user first creates channel 14 within a curb, and subsequently creates a pilot hole 130 within channel 14. Cable 10 is placed within channel 14 near pilot hole 130, and anchor 100 is forced within pilot hole 130, securing cable 10 within channel 14. In one embodiment, pilot hole 130 has a 0.25″ diameter and anchor 100 is driven into pilot hole 130, such as via a hammer.

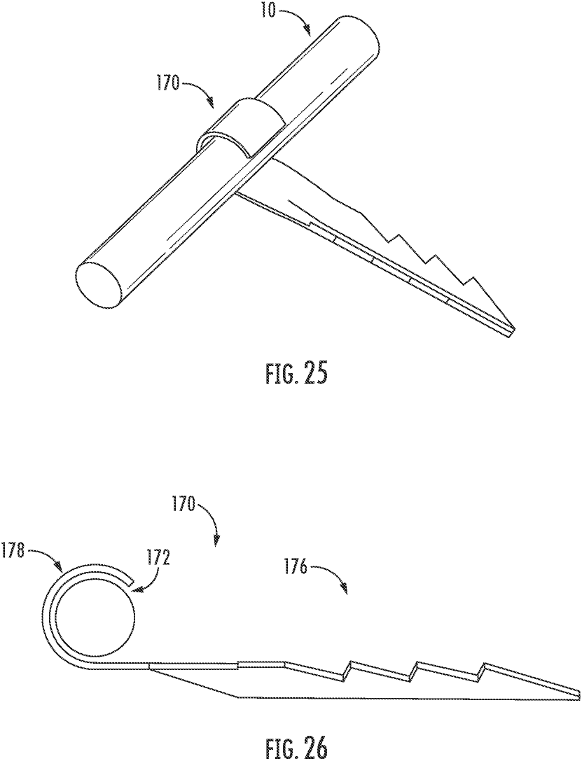

Turning to FIGS. 25-30, various embodiments of anchor 170 are shown. Anchor 170 is substantially the same as anchor 100 except for the differences discussed herein. Cable 10 is forced into head 178 through head opening 172. In one embodiment, head opening 172 has a height 174 that is slightly less than a diameter and/or width of cable 10. In one embodiment, height 174 is 0.5 mm less than a diameter and/or width of cable 10 (shown in the schematic depicted in FIG. 27), providing an interference fit between head 178 and cable 10 when cable 10 is moved into or out of the interior portion of head 178. As shown in FIG. 27, in one embodiment, the diameter and/or height of cable 10 is slightly larger than height 174 of opening 172.

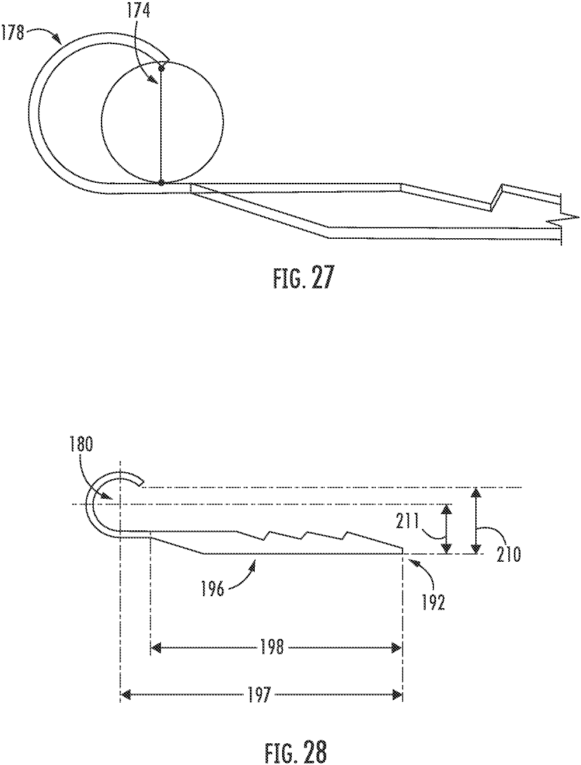

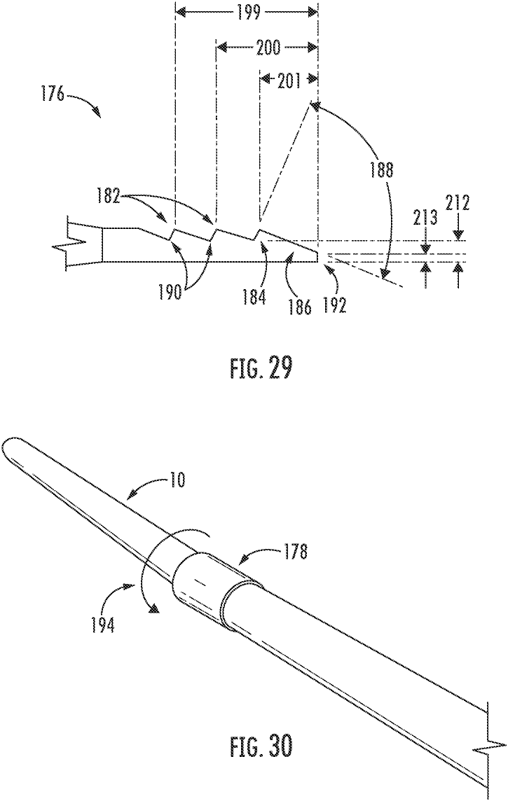

Turning to FIGS. 28 and 29, in one embodiment, anchor 170 has a height 211 of 7.1 millimeters (mm) from bottom surface 196 to center 180 of head 178, and a height 210 of 9.8 mm from bottom surface 196 to the lower surface of the upper portion of head 178. Body 176 has a length 198 of 38 mm from end 192 to the connection between body 176 and head 178, and a length 197 of 42.8 mm from end 192 to center 180 of head 178. The protrusion 182 has a length 201 of 8.36 mm from end 192, the next protrusion 182 has a length 200 of 14.27 mm from end 192, and the next protrusion 182 has a length 199 of 20.17 mm from end 192.

The first protrusion 182 nearest end 192 defines first surface 184 and second surface 186. First surface 184 extends from recess 190 nearest end 192 to protrusion 182 nearest end 192, and second surface 186 extends from protrusion 182 to end 192. First surface 184 and second surface 186 collectively define an angle 188 that is 90 degrees. End 192 extends to a height 213 of 1.3 mm from bottom surface 196 to second surface 186. Recess 190 has a height 212 of 2.9 mm above bottom surface 196. In one embodiment, material of head 178 has a thickness of 0.54 mm.

Turning to FIG. 30, cable 10 is lightly secured within head 178 (e.g., by forcing cable 10 through head opening 172 that is sized to be slightly smaller than cable 10). Subsequently, anchor 170 is driven into a hole, such a hole in concrete and/or masonry. As anchor 170 is driven into the hole, in one embodiment, head 178 deforms in direction 194 around cable 10, further securing cable 10 within head 178. In one embodiment, anchor 100 and/or anchor 170 is driven into a road by a saddle-faced tool with a concave end that engages around the curved outer surface of head 178 to encourage head 178 to curl around cable 10. The concave end of the saddle-faced tool is supported by one or more support bars that extend upward from the concave end when in use.

In one embodiment, anchor 100 and/or anchor 170 is a one-piece stainless steel component.

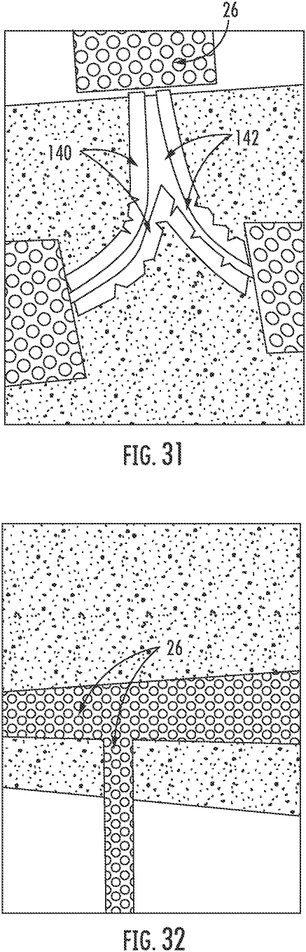

Turning to FIGS. 31 and 32, another approach is to create a channel above the road by applying tape to either side of the desired location of the channel. Tape 140 is adhered to road 16 to laterally define channel 142. Channel 142 is also defined beneath by road 16 and has an open top side until tape 26 covers channel 142. Tape 26 is placed above channel 142 after cable 10 is placed within channel 142.

Turning to FIG. 33, another approach is to enable cable 10 to have a tighter turn radius by severing strength members 150. Cable 10 has strength members 150, which are severed proximate to where cable 10 is curved. As a result, cable 10 can be curved in a smaller radius than would otherwise be possible due to the stiffness of cable 10.

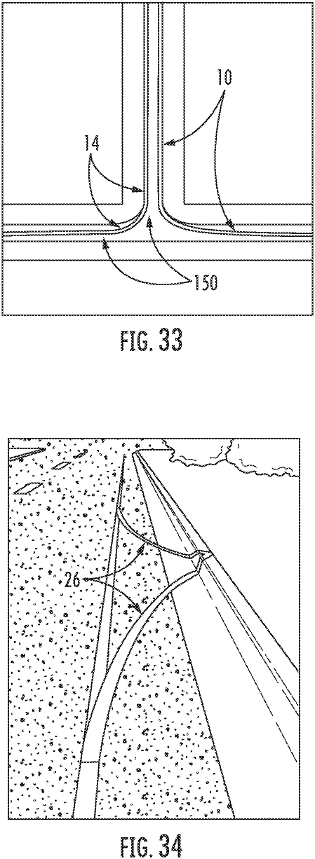

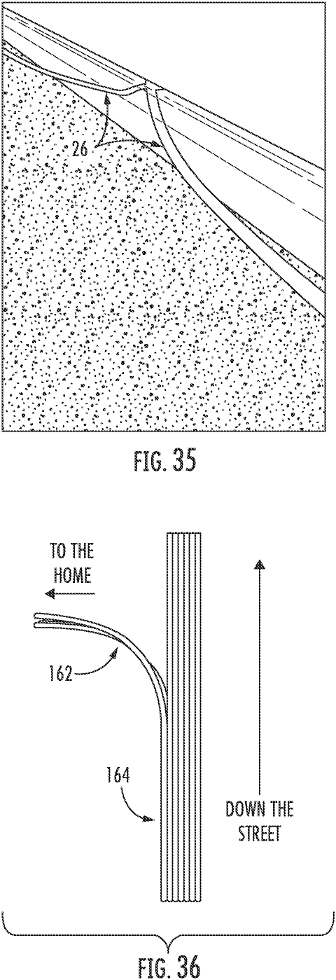

Turning to FIGS. 34 and 35, another approach is to slowly curve cable 10 via a larger radius. For this approach, the curve of cable 10 from primary channel 64 is very small (e.g., the curve has a relatively large radius).

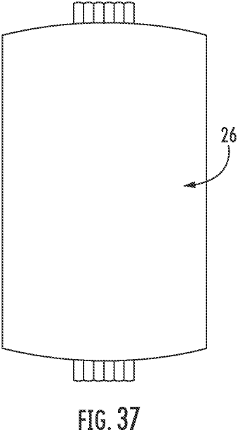

Turning to FIGS. 36 and 37, another approach is to divert a single fiber cable 162 from cable 10. In one specific embodiment, cable 10 is covered by tape 26 after cable 10 is placed in primary channel 64.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of deploying an optical fiber carrying structure comprising:
creating a recess in a road, the first recess defining a first depth below an outer surface of the road, the recess defining a base surface and a first width;
creating a first channel in the road, the first channel defining a second depth below the outer surface of the road and a second width, wherein the first channel extends downward from the base surface of the recess such that the second depth is greater than the first depth and the second width is less than the first width;
placing an optical fiber carrying structure downward through the recess and into the first channel; and
affixing a cover within the recess above the optical fiber carrying structure while the optical fiber carrying structure is in the first channel, thereby enclosing the optical fiber carrying structure within the first channel.

2. The method of claim 1 further comprising:
creating a second recess in the road, wherein the second recess defines a third depth and a third width;
creating a second channel in the road, wherein the second channel defines a fourth depth that is greater than the third depth and a fourth width that is less than the third width, wherein a majority of the second channel opens into the second recess; and
wherein the second channel extends from the first channel.

3. The method of claim 2 further comprising:
creating a third channel in the road, wherein the third channel defines a fifth depth that is greater than the third depth and a fifth width that is less than the third width, wherein a majority of the third channel opens into the second recess; and
wherein the third channel extends from the first channel.

4. The method of claim 3, wherein the second channel and the third channel extend parallel to each other.

5. The method of claim 2 further comprising:
creating a first arced channel in the road, wherein the first arced channel defines a sixth depth that is greater than the third depth and a sixth width that is less than the third width, wherein the first arced channel extends between the first channel and the second channel, and wherein the first arced channel defines an arc; and
creating a second arced channel in the road, wherein the second arced channel defines a seventh depth that is greater than the third depth and a seventh width that is less than the third width, wherein the second arced channel extends between the first channel and the second channel, and wherein the second arced channel defines an arc, and wherein the first arced channel and the second arced channel arc away from each other when viewed from the second channel.

6. The method of claim 5 further comprising:
adhering backfill to the road where the first arced channel, the second arced channel, and the second channel intersect.

7. The method of claim 1, wherein a majority of the recess has a first width that is between 1 inch and 3 inches.

8. The method of claim 1, wherein the first channel and the recess are formed simultaneously.

9. A method of deploying an optical fiber carrying structure comprising:
creating a first channel in a road;
creating a second channel in the road, wherein the second channel extends between the first channel and a side of the road;
coupling an optical fiber carrying structure to a brace, wherein the optical fiber carrying structure extends along a longitudinal axis, and wherein a first portion of the optical fiber carrying structure extends from the brace at a first direction along the first channel and a second portion of the optical fiber carrying structure extends from the brace at a second direction along the second channel, and wherein an angle between the first direction and the second direction is between 70 degrees and 110 degrees.

10. The method of claim 9, wherein the first direction and the second direction are generally planar.

11. The method of claim 9, wherein the brace comprises a primary wall that defines an outer arcuate surface, and wherein the optical fiber carrying structure is coupled to the brace so that the optical fiber carrying structure interfaces against the outer arcuate surface.

12. The method of claim 11, wherein brace further comprises a first orientation-adjusting coupling that horizontally orients the optical fiber carrying structure when the optical fiber carrying structure extends from the brace in the first direction.

13. The method of claim 12, wherein brace further comprises a second orientation-adjusting coupling that horizontally orients the optical fiber carrying structure when the optical fiber carrying structure extends from the brace in the second direction.

14. The method of claim 11, wherein the optical fiber carrying structure is coupled against the outer arcuate surface in a vertical orientation.

15. The method of claim 11 further comprising:
affixing a cover to the road, wherein the cover is positioned above the outer arcuate surface of the brace.

16. A method of deploying an optical fiber carrying structure comprising:
identifying a first channel in a material selected from the group consisting of a curb, a roadbed, a sidewalk, a gutter, and a wall;
placing an optical fiber carrying structure within the first channel; and
sinking an anchor into the first channel, wherein the anchor restrains the optical fiber carrying structure within the first channel.

17. The method of claim 16, wherein the anchor comprises an anchoring portion that is inserted into the curb and a secondary wall that extends from an upper end of the anchoring portion, wherein the secondary wall restrains the optical fiber carrying structure within the first channel.

18. The method of claim 16, the method further comprising:
creating the first channel in the material selected from the group consisting of a curb, a roadbed, a sidewalk, a gutter, and a wall, wherein the step of identifying the first channel comprises identifying the created first channel.

19. The method of claim 16, wherein the anchoring portion defines a first lateral surface and a second lateral surface, wherein each of the first lateral surface and the second lateral surface define an alternating series of protrusions and recesses.

20. The method of claim 19, wherein the anchoring portion comprises a first wall that defines the first lateral surface and a second wall that defines the second lateral surface, wherein the first wall and the second wall are coupled together at an angle between 60 degrees and 120 degrees.
